(19) United States
(12) Patent Application Publication
(10) Pub. No.: US 2007/0034641 A1
(43) Pub. Date: Feb. 15, 2007

(54) Ball carrier apparatus

(76) Inventor: Wen-Sheng Huang, Tunghsiao Town (TW)

Correspondence Address: TROXELL LAW OFFICE PLLC, SUITE 1404, 5205 LEESBURG PIKE, FALLS CHURCH, VA, 22041, US

(21) Appl. No.: 11/395,230

(22) Filed: Apr. 3, 2006

(30) Foreign Application Priority Data
Aug. 12, 2005 (TW) 094213874

(51) Int. Cl. B65G 59/00

(52) U.S. Cl. 221/269

(57) ABSTRACT

A ball carrier apparatus including: a main body defining a chamber in which balls or the like can be accommodated, the main body being formed with a window communicating the chamber with outer side, whereby the balls or the like can be placed into the chamber or taken out of the chamber; and a valve sleeve reciprocally movably fitted around the main body. In a blocking position, the valve sleeve shuts off the window of the main body. However, in the case that an external force is applied to the valve sleeve to move the valve sleeve away from the window, the valve sleeve unblocks the window, permitting the balls or the like to get into or get out of the chamber.

### BACKGROUND OF THE INVENTION

The present invention is related to a ball carrier apparatus which has simple structure and can be easily carried and used. The balls or the like can be accommodated in the ball carrier apparatus and easily carried by a player of a game.

Various apparatuses for all kinds of ball games have been developed. For example, Taiwanese Patent No. 86207705 discloses an improved golf bag leg support. Taiwanese Patent No. 85201421 discloses a golf club handle. Taiwanese Patent No. 86221398 discloses a golf club head. Taiwanese Patent No. 85214077 discloses a golf ball picker. Taiwanese Patent No. 85215391 discloses a golf ball package box. Taiwanese Patent No. 85202012 discloses a golf club shaft. Taiwanese Patent No. 84211479 discloses a golf club fixing rack. Taiwanese Patent No. 83212308 discloses a golf ball tee. Taiwanese Patent No. 78204006 discloses a golf club head cover. Taiwanese Patent No. 86221562 discloses a ping-pong ball picker. Taiwanese Patent No. 88204157 discloses a ping-pong net support. Taiwanese Patent No. 79202653 discloses a ping-pong ball ejector. Taiwanese Patent No. 85203563 discloses a ping-pong scoring aid.

In a ball game such as golf, a player often needs to prepare extra balls as necessary. In practice, two or three balls are placed in a pocket or carried by an assistant. This is quite inconvenient. Therefore, Taiwanese Patent No. 87205462 discloses a golf ball bag having an elastic lining. When golf balls are placed into the golf ball bag, the elastic lining is resiliently deformed to hold the golf balls. However, such golf ball bag must allow a user's fingers to extend in so that the structure of the golf ball bag is large and complicated. In addition, the lining must have sufficient elasticity for holding the golf balls. Moreover, when taking out the golf balls, the golf ball bag tends to drop down and damage. Therefore, it is inconvenient to carry or use such golf ball bag.

### SUMMARY OF THE INVENTION

It is therefore a primary object of the present invention to provide a ball carrier apparatus which has simple structure and can be easily carried and used.

According to the above object, the ball carrier apparatus includes: a main body defining a chamber in which balls or the like can be accommodated, the main body being formed with a window communicating the chamber with outer side, whereby the balls or the like can be placed into the chamber or taken out of the chamber; and a valve sleeve reciprocally movably fitted around the main body. In a blocking position, the valve sleeve shuts off the window of the main body. However, in the case that an external force is applied to the valve sleeve to move the valve sleeve away from the window, the valve sleeve unblocks the window, permitting the balls or the like to get into or get out of the chamber.

A conic hole is formed on a bottom portion of the main body and a locating section is installed in the conic hole for keeping the valve sleeve in the blocking position where the valve sleeve shuts off the window of the main body. The locating section includes a flexible leaf spring and a ball body pushed outward by the leaf spring to hinder the valve sleeve from moving. When an external force is applied to the valve sleeve to move the valve sleeve away from the window, the valve sleeve unblocks the window, permitting the balls or the like to get into or get out of the chamber.

The main body is pivotally connected with a retainer ring and an elastic cord. The other end of the elastic cord is connected with a buckle. The buckle can be fastened on a belt of a user. The retainer ring is looped with the buckle. When the user releases the retainer ring from the buckle, the user can through the elastic cord pull the main body to reciprocally move the valve sleeve for obtaining spare balls or the like.

The present invention can be best understood through the following description and accompanying drawings wherein:

### BRIEF DESCRIPTION OF THE DRAWINGS

FIG. 1 is a perspective assembled view of the ball carrier apparatus of the present invention;

FIG. 2 is a perspective exploded view of the ball carrier apparatus of the present invention;

FIG. 3 is a perspective view according to FIG. 1, in which the valve sleeve is moved upward to unblock the window of the main body of the ball carrier apparatus;

FIG. 4 is an enlarged sectional view showing the relationship between the locating section of the main body and the valve sleeve of the ball carrier apparatus;

FIG. 5 is a sectional view of the ball carrier apparatus of the present invention, in which several balls are accommodated in the main body and the window of the main body is shut off by the valve sleeve;

FIG. 6 is a sectional view according to FIG. 5, in which the valve sleeve is moved upward to unblock the window of the main body, permitting the balls to be taken out;

FIG. 7 is a perspective view showing that the ball carrier apparatus of the present invention is equipped with a retainer ring, an elastic cord and a buckle; and

FIG. 8 shows that the ball carrier apparatus of the present invention is hung and fastened on a belt of a user.

### DETAILED DESCRIPTION OF THE PREFERRED EMBODIMENTS

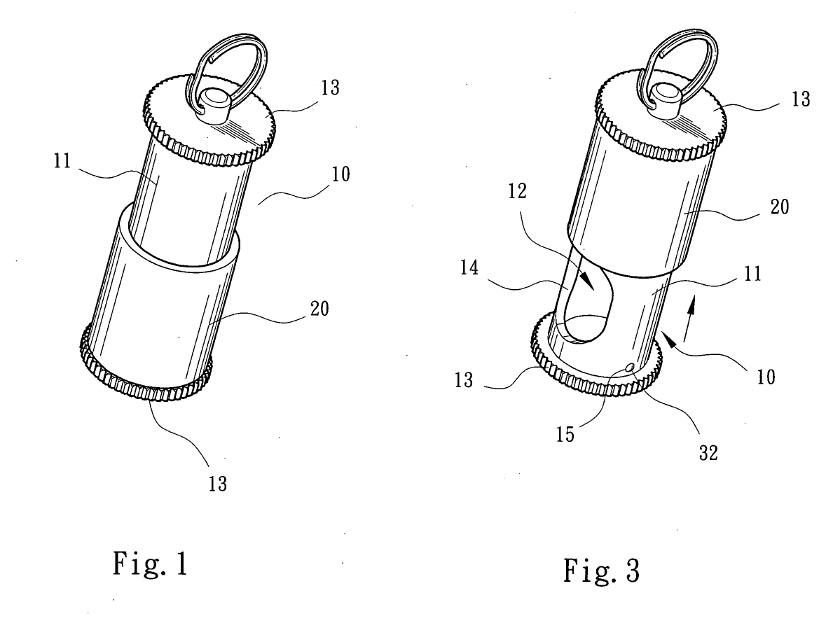

Please refer to FIGS. 1 to 3. The ball carrier apparatus of the present invention includes a main body 10. In this embodiment, the main body 10 is a tubular body having a circumferential wall 11 defining a chamber 12. Balls or the like 40 (as shown in FIG. 5) can be accommodated in the chamber 12. The ball carrier apparatus of the present invention further includes a valve sleeve 20 reciprocally movably fitted around the main body 1. The main body 10 has two open ends. Two caps 13 are respectively connected with the two ends of the main body 10 to seal the two ends. In a preferred embodiment, the outer diameter of the cap 13 is larger than the diameter of the main body 10.

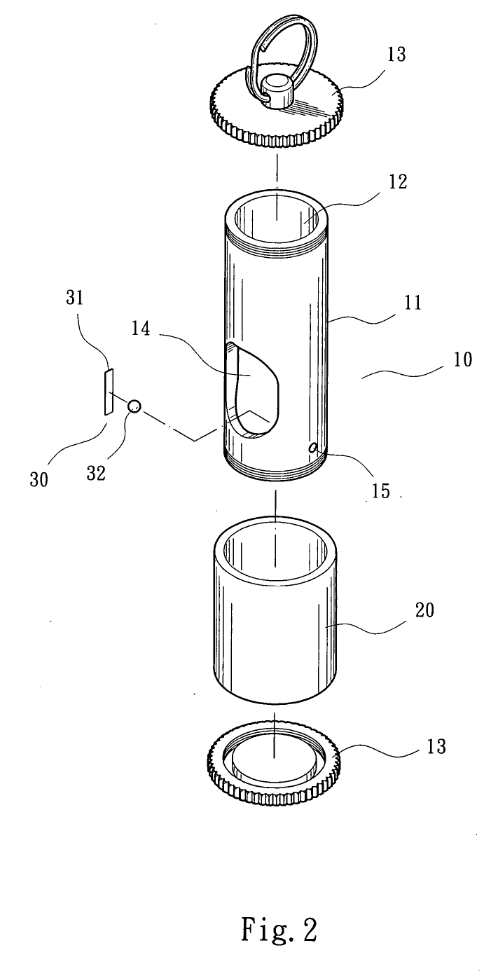

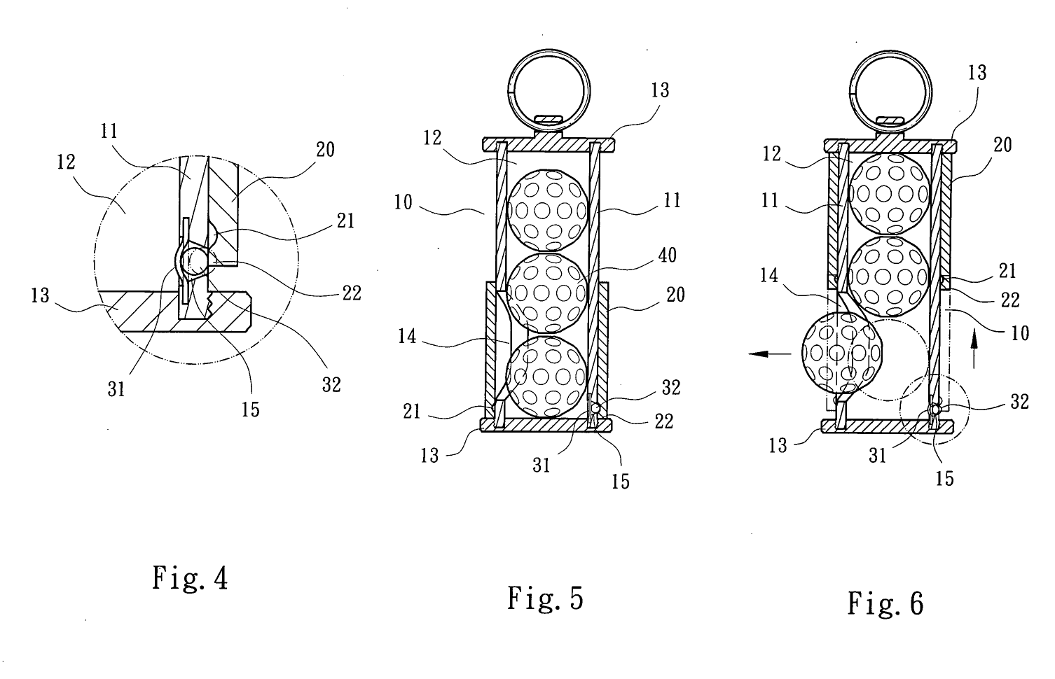

The main body 10 is also formed with a window 14 on a predetermined portion of the circumferential wall 11. The chamber 12 can communicate with outer side through the window 14, whereby the balls or the like 40 can be placed into the chamber 12 or taken out of the chamber 12. Referring to FIGS. 2 and 4, a conic hole 15 is formed on a bottom portion of the circumferential wall 11 of the main body 10. A locating section 30 is installed in the conic hole 15 for keeping the valve sleeve 20 in a blocking position where the valve sleeve 20 shuts off the window 14. In a preferred embodiment, the locating section 30 includes a flexible leaf spring 31 and a ball body 32 pushed outward by the leaf spring 31 to hinder the valve sleeve 20 from moving.

The valve sleeve 20 has an inner diameter larger than the outer diameter of the main body 10. Also, the valve sleeve 20 has two open ends, whereby the valve sleeve 20 can reciprocally move along the main body 10. Referring to FIG. 4, a recess 21 is formed on an inner circumference of a lower end 22 of the valve sleeve 20. The ball body 32 is inlaid in the recess 21 to hinder the valve sleeve 20 from unexpectedly moving.

Referring to FIGS. 5 and 6, in a restricting state, the leaf spring 31 makes the ball body 32 positioned in the conic hole 15 partially protrude from the main body 10 into the recess 21 of the valve sleeve 20. Under such circumstance, the valve sleeve 20 shuts off the window 14 of the main body 10. In the case that an external force is applied to the valve sleeve 20 to move the valve sleeve 20 upward, the valve sleeve 20 unblocks the window 14, permitting the balls or the like 40 to get into or get out of the chamber 12 as shown in FIG. 6.

Referring to FIG. 4, when the valve sleeve 20 is moved upward, the ball body 32 is pressed inward against the leaf spring 31. At this time, the leaf spring 31 is bent and deformed to reserve resilient energy. After the valve sleeve 20 leaves the locating section 30, the resilient energy is released to restore the ball body 32 back to its home position as shown by the phantom line of FIG. 4.

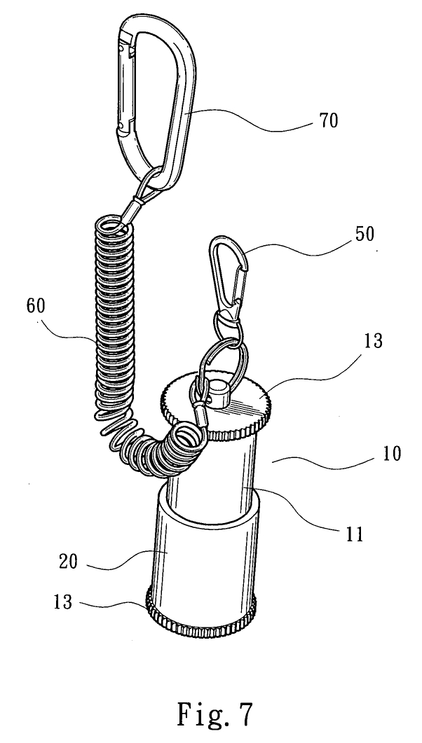

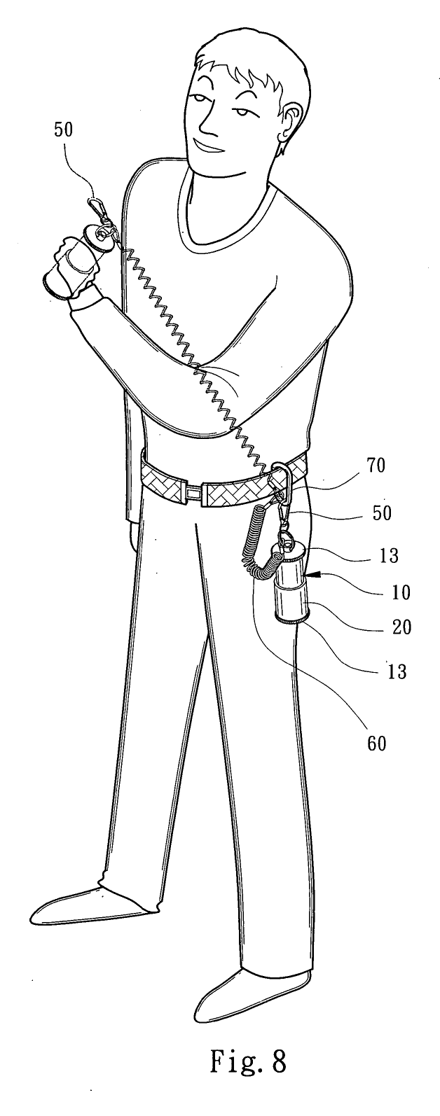

Referring to FIGS. 7 and 8, the cap 13 is pivotally connected with a retainer ring 50 and an elastic cord 60. The other end of the elastic cord 60 is connected with a buckle 70 which can be fastened on a belt of a user. The retainer ring 50 is looped with the buckle 70. When the user releases the retainer ring 50 from the buckle 70, the user can through the elastic cord 60 pull the main body 10 to reciprocally move the valve sleeve 20 for obtaining spare balls or the like 40 as shown by the phantom line of FIG. 8.

The retainer ring 50, elastic cord 60 and the buckle 70 facilitate the carriage and use of the ball carrier apparatus. In addition, the buckle 70 and the elastic cord 60 further protect the ball carrier apparatus from incautiously suddenly dropping onto the ground during the game. Therefore, the ball carrier apparatus will not directly drop onto the ground and damage. Also, the buckle 70 and the elastic cord 60 prevent the ball carrier apparatus from missing.

The above embodiments are only used to illustrate the present invention, not intended to limit the scope thereof. Many modifications of the above embodiments can be made without departing from the spirit of the present invention.

What is claimed is:

1. A ball carrier apparatus comprising:
a main body defining a chamber in which balls or the like can be accommodated, the main body being formed with a window communicating the chamber with outer side, whereby the balls or the like can be placed into the chamber or taken out of the chamber; and
a valve sleeve reciprocally movably fitted around the main body, whereby in a blocking position, the valve sleeve shuts off the window of the main body, while in the case that an external force is applied to the valve sleeve to move the valve sleeve away from the window, the valve sleeve unblocks the window, permitting the balls or the like to get into or get out of the chamber.

2. The ball carrier apparatus as claimed in claim 1, wherein the main body has two open ends and two caps are respectively connected with the two ends of the main body to seal the two ends, an outer diameter of the cap being larger than a diameter of the main body.

3. The ball carrier apparatus as claimed in claim 1, wherein a conic hole is formed on a bottom portion of the main body and a locating section is installed in the conic hole for keeping the valve sleeve in the blocking position where the valve sleeve shuts off the window of the main body.

4. The ball carrier apparatus as claimed in claim 3, wherein the locating section includes a flexible leaf spring and a ball body pushed outward by the leaf spring to hinder the valve sleeve from moving.

5. The ball carrier apparatus as claimed in claim 4, wherein a recess is formed on an inner circumference of a lower end of the valve sleeve, whereby the leaf spring makes the ball body positioned in the conic hole partially protrude from the main body into the recess of the valve sleeve for keeping the valve sleeve in the blocking position where the valve sleeve shuts off the window.

6. The ball carrier apparatus as claimed in claim 1, wherein the main body is a tubular body.

7. The ball carrier apparatus as claimed in claim 1, wherein the valve sleeve has an inner diameter larger than the outer diameter of the main body, the valve sleeve having two open ends, whereby the valve sleeve can reciprocally move along the main body.

8. The ball carrier apparatus as claimed in claim 2, wherein one of the caps is pivotally connected with a retainer ring and an elastic cord, the other end of the elastic cord being connected with a buckle.
